(19) United States
(12) Patent Application Publication
(10) Pub. No.: US 2018/0312732 A1
(43) Pub. Date: Nov. 1, 2018

(54) REDUCED VOC TIRE CEMENT

(71) Applicant: Bridgestone Americas Tire Operations, LLC, Nashville, TN (US)

(72) Inventors: Ross W. Widenor, Munroe Falls, OH (US); Amy M. Randall, Brentwood, TN (US)

(21) Appl. No.: 15/769,878

(22) PCT Filed: Oct. 13, 2016
(86) PCT No.: PCT/US16/56723

§ 371 Date: Apr. 20, 2018

Related U.S. Application Data
(60) Provisional application No. 62/245,086, filed on Oct. 22, 2015.

(51) Int. Cl. C09J 107/00; C09J 11/04

(52) U.S. Cl. CPC C09J 107/00; C09J 11/04

(57) ABSTRACT

Disclosed herein are adhesive compositions comprising at least one conjugated diene-containing polymer or copolymers, including natural rubber, and a liquid terpene-based solvent, wherein the adhesive composition is essentially free of petroleum-based solvents and petroleum-based resins. Also disclosed are curable adhesive composition embodiments further comprising a cure package. A related process for adhering two tire components together using a curable adhesive composition is also disclosed as is a tire comprising two components adhered by a specified process including use of a curable adhesive composition.

### FIELD OF THE DISCLOSURE

The present disclosure relates to adhesive compositions for tires, curable compositions thereof, and processes for adhering together tire components using the compositions.

### BACKGROUND

Articles made from rubber components may be joined together with various types of adhesive. Adhesives can be applied to the surface of materials and are often used to promote adhesion of various components. Adhered components are generally bound together to some degree such that they resist separation when force is applied. In the tire industry, such adhesives are sometimes called cements and are used to promote adhesion of rubber components. Generally these are adhesives made from rubber polymer(s) dissolved in volatile solvents that are petroleum-based or sourced. A volatile organic compound (VOC) is a carbon-based compound that will vaporize at room temperature. Exposure to high levels of VOC emissions is shown to have negative health impacts. The solvents commonly include heptanes and hexanes.

### SUMMARY

Disclosed herein are adhesive compositions for tires, curable compositions thereof, and processes for adhering together tire components using the compositions.

In a first embodiment, an adhesive composition comprising at least one conjugated diene-containing polymer or copolymer including natural rubber and a liquid terpene-based solvent, wherein the adhesive composition is essentially free of petroleum-based solvents and petroleum-based resins is disclosed. The adhesive composition comprises about 60% to about 95% by weight of liquid terpene-based solvent.

In a second embodiment, a curable adhesive composition comprising at least one conjugated diene-containing polymer or copolymers including natural rubber and a liquid terpene-based solvent, wherein the adhesive composition is essentially free of petroleum-based solvents and petroleum-based resins is disclosed. The curable adhesive composition in this embodiment also comprises a cure package.

In a third embodiment, a process for adhering two tire components together is provided. The method comprises (a) providing a first tire component having a first rubber surface, and applying to at least a portion of the first rubber surface a curable adhesive composition comprising at least one conjugated diene-containing polymer or copolymer including natural rubber, a liquid terpene-based solvent, and a cure package, wherein the curable adhesive composition is essentially free of petroleum-based solvents and petroleum-based resins; (b) providing a second tire component having a second rubber surface; and (c) contacting at least a portion of the second rubber surface with at least a portion of the adhesive-containing first rubber surface to form two adhered components.

In a fourth embodiment, a tire comprising two components adhered by a specified process is disclosed. The process comprises (a) providing a first tire component having a first rubber surface, and applying to at least a portion of the first rubber surface a curable adhesive composition comprising at least one conjugated diene-containing polymer or copolymer including natural rubber, a liquid terpene-based solvent, and a cure package, wherein the curable adhesive composition is essentially free of petroleum-based solvents and petroleum-based resins; (b) providing a second tire component having a second rubber surface; and (c) contacting at least a portion of the second rubber surface with at least a portion of the adhesive-containing first rubber surface to form two adhered components.

### BRIEF DESCRIPTION OF THE DRAWINGS

FIG. 1 is a graph showing the efficacy of adhesive compositions comprising terpene-based solvent, as compared to an adhesive composition comprising conventional petroleum-based solvent, measured by the relative peel resistance of the adhesive bond between two adhered components.

FIG. 2 is a graph showing the effect of reinforcing filler and cure agents on the adhesion properties of adhesive compositions comprising terpene-based solvent, as compared to adhesive compositions comprising terpene-based solvent without reinforcing filler or cure agents, measured by the relative peel resistance of the adhesive bond between two adhered components.

### DETAILED DESCRIPTION

Disclosed herein are adhesive compositions for tires, curable compositions thereof, and processes for adhering together tire components using the compositions.

In a first embodiment, an adhesive composition comprising: (a) 100 parts of at least one conjugated diene-containing polymer or copolymer including natural rubber; and (b) about 60% to about 95% by weight a liquid terpene-based solvent, wherein the adhesive composition is essentially free of petroleum-based solvents and petroleum-based resins is disclosed. The adhesive composition comprises about 60% to about 95% by weight of liquid terpene-based solvent.

In a second embodiment, a curable adhesive composition comprising: (a) 100 parts of at least one at least one conjugated diene-containing polymer or copolymers including natural rubber; (b) about 60% to about 95% by weight of a liquid terpene-based solvent; and (c) a cure package, wherein the adhesive composition is essentially free of petroleum-based solvents and petroleum-based resins is disclosed.

In a third embodiment, a process for adhering two tire components together is provided. The method comprises (a) providing a first tire component having a first rubber surface, and applying to at least a portion of the first rubber surface a curable adhesive composition comprising at least one conjugated diene-containing polymer or copolymer including natural rubber, a liquid terpene-based solvent, and a cure package, wherein the curable adhesive composition is essentially free of petroleum-based solvents and petroleum-based resins; (b) providing a second tire component having a second rubber surface; and (c) contacting at least a portion of the second rubber surface with at least a portion of the adhesive-containing first rubber surface to form two adhered components. In certain embodiments of the third embodiment, the process can be understood as utilizing a curable adhesive composition according to the second embodiment disclosed herein.

In a fourth embodiment, a tire comprising two components adhered by a specified process is disclosed. The process comprises (a) providing a first tire component having a first rubber surface, and applying to at least a portion of the first rubber surface a curable adhesive composition comprising at least one conjugated diene-containing polymer or copolymer including natural rubber, a liquid terpene-based solvent, and a cure package, wherein the curable adhesive composition is essentially free of petroleum-based solvents and petroleum-based resins; (b) providing a second tire component having a second rubber surface; and (c) contacting at least a portion of the second rubber surface with at least a portion of the adhesive-containing first rubber surface to form two adhered components. In certain embodiments of the fourth embodiment, the process can be understood as utilizing a curable adhesive composition according to the second embodiment disclosed herein.

### Definitions

The terminology as set forth below is for description of the embodiments disclosed herein and should not be construed as limiting the invention as a whole.

As used herein, the term “adhesive,” as in an “adhesive composition,” means a composition capable of adhering two rubber components together after adding an amount of 1 g/ft² to 15 g/ft², including 1 g/ft² to 12 g/ft², 1 g/ft² to 10 g/ft², 1 g/ft² to 8 g/ft², 1 g/ft² to 7 g/ft², 1 g/ft² to 6 g/ft², 1 g/ft² to 5 g/ft², as well as 3 g/ft² to 15 g/ft², 3 g/ft² to 12 g/ft², 3 g/ft² to 10 g/ft², 3 g/ft² to 8 g/ft², 3 g/ft² to 7 g/ft², 5 g/ft² to 15 g/ft², 5 g/ft² to 12 g/ft², 5 g/ft² to 10 g/ft², 5 g/ft² to 8 g/ft², and 5 g/ft² to 7 g/ft², to one or more rubber components to be adhered and curing said adhesive at 145° C. for 33 minutes at 100 psi pressure. As used herein, the terms “adhere” and “adhering,” for example, “adhering two rubber components together,” means holding the two components together with sufficient strength to withstand at least 300N of separating force as measured by the peel resistance of the adhesive bond between two rubber components using an intervening nylon mesh interface between the surfaces of the rubber components to prevent fracturing of the rubber sheets.

As used herein, the term “natural rubber” means naturally occurring rubber such as can be harvested from sources such as Hevea rubber trees, and non-Hevea source (e.g., guayule shrubs, and dandelions (e.g., TKS). In other words, the term “natural rubber” should not be construed as including polyisoprene.

As used herein, the term “styrene-butadiene rubber” means a copolymer manufactured from the polymerization of styrene and cis-1,3-butadiene monomers. In certain embodiments, the copolymer consists of randomly linked styrene and butadiene monomers rather than sequences of polystyrene chains separated by sequences of butadiene chains. Furthermore, in certain embodiments, the styrene-butadiene rubber described herein is thermoset, as compared to thermoplastic, in nature. In other words, such a styrene-butadiene rubber is made of polymer structures which, when cured or vulcanized, form irreversibly cross-linked polymer chains.

As used herein, the term “phr” means the parts by weight per hundred parts of rubber. If the rubber component of the adhesive composition comprises more than one rubber, “phr” means the parts by weight per hundred parts of the sum of all rubbers.

As used herein, the term “majority” means greater than 50% by weight.

For the purpose of this disclosure, any reference to a percent amount of a component in the adhesive composition means a percent by weight, unless otherwise specified.

### Liquid Terpene-Based Solvent

According to the embodiments disclosed herein, the adhesive composition comprises one or more than one liquid terpene-based solvent. A liquid terpene-based solvent is a compound that is a liquid at room temperature (25° C.), that is capable of dissolving rubbery polymers such as natural rubber, isoprene rubber, and styrene-butadiene rubber, and that includes a majority of at least one terpene. Terpenes are organic compounds produced by plants such as conifers. They are comprised of units of isoprene linked into linear chains or rings, many, but not all, of which are aromatic. Suitable terpene-based solvents include, but are not limited to, d-limonene, carvone, pinene, pine needle oil, citral, orange oil, dodecane, decane, undecane, dipentene, 1,8-cineole, eucalyptol, citronellol, geraniol, citronellene, terpinen-4-ol, and combinations thereof, as well as compounds (solvents) containing a majority of one or more of the foregoing terpenes. Suitable liquid terpene-based solvents may also include other terpenes.

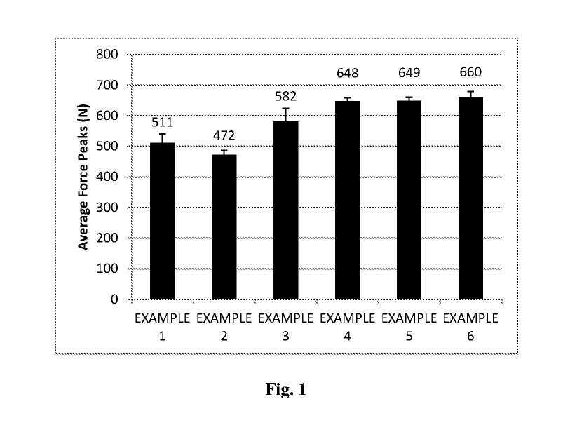

In certain embodiments, the liquid terpene-based solvent having low volatility, can be described as less toxic than petroleum-based or petroleum-derived solvents currently used in rubber cement compositions. The current disclosure relates to the use of liquid terpene-based solvents of low volatility in adhesive compositions as compared to petroleum-based or petroleum-derived solvents, without the addition of co-solvents, the adhesive compositions of which exhibit equivalent adhesion performance results. The relative adhesion measured by the force required to separate two rubber components adhered by the adhesive compositions such as those disclosed herein comprising varying levels of liquid terpene-based solvent as compared to conventional petroleum-based or petroleum-derived solvent is shown in FIG. 1, the formulations of which are further described in later examples.

In one or more embodiments, the adhesive composition comprises about 60% to about 95% by weight of liquid terpene-based solvent. As discussed above, the liquid terpene-based solvent is used in the adhesive composition or curable adhesive composition in an amount of about 60% to about 95% by weight, including 60% to 95%. In certain embodiments, the amount of liquid terpene-based solvent by weight is about 65% to about 85%, including 65% to 85%, about 70% to about 80%, 70% to 80%, about 75% to about 90%, 75% to 90%, about 80% to about 95%, and 80% to 95%.

In one or more embodiments, the liquid terpene-based solvent comprises citrus oil. Non-limiting examples of suitable citrus oils include orange oil, lemon oil, lime oil, grapefruit oil, and combinations thereof. In one or more embodiments, the terpene-based solvent comprises a majority by weight of d-limonene. D-limonene can be extracted from citrus rind and is a major component of citrus oils. D-limonene is a relatively stable terpene. It oxidizes easily when exposed to humidity to produce carveol, carvone, and limonene oxide, which range in water solubility from insoluble to slightly soluble. In the presence of sulfur, d-limonene undergoes dehydrogenation to form p-cymene, which is insoluble in water.

In one or more embodiments disclosed herein, the liquid terpene-based solvent is essentially free of water. In these embodiments, the presence of water is avoided as it could result in undesirable separation of the uncured adhesive compositions. As used herein, the phrase “essentially free of water” should be understood as meaning absent the addition or presence of any exogenous water. In other words, the phrase “essentially free of water” should be understood as meaning absent any water not inherent to the terpene-based compound(s) comprising the liquid terpene-based solvent. For example, the adhesive composition of one or more embodiments disclosed herein comprises less than 1% water.

### Rubber Polymer(s)

According to the embodiments disclosed herein, the adhesive composition or the curable adhesive composition comprises at least one of a conjugated diene-containing polymer or copolymers, including natural rubber. In other words, the at least one conjugated diene-containing polymer or copolymer includes at least natural rubber. In those embodiments where at least one conjugated diene-containing polymer or copolymer is used, such as in addition to the natural rubber, the polymer(s) and/or copolymer(s) may vary. In certain embodiments, the at least one additional conjugated diene-containing polymer or copolymer is selected from, but not limited to, polyisoprene, poly(styrene-butadiene), poly(isoprene-styrene), poly(isoprene-butadiene), polybutadiene, polychloroprene, nitrile rubber, butyl rubber, terpolymers of isoprene, styrene, and butadiene, and combinations thereof.

In one or more embodiments, the at least one of a conjugated diene-containing polymer or copolymer comprises a majority by weight of natural rubber. In other words, such adhesive compositions comprise greater than 50 phr, such as up to about 60 phr, up to 60 phr, up to about 70 phr, up to 70 phr, up to about 80 phr, up to 80 phr, up to about 90 phr, up to 90 phr, up to about 100 phr, or up to 100 phr of natural rubber. In one or more of these embodiments, the at least one conjugated diene-containing polymer comprises at least one polymer or copolymer selected from, but not limited to, styrene-butadiene copolymer, polybutadiene, and polyisoprene, in addition to the natural rubber. In other words, such adhesive compositions comprise less than 50 phr, such as up to about 40 phr, up to 40 phr, up to about 30 phr, up to 30 phr, up to about 20 phr, up to 20 phr, up to about 10 phr, up to 10 phr of the foregoing polymers or copolymers.

### Reinforcing Filler

In certain embodiments disclosed herein, the adhesive composition comprises at least one reinforcing filler. In one or more of these embodiments, the total amount of reinforcing filler may range from about 25 phr to about 75 phr, including 25 phr to 75 phr, about 30 phr to about 60 phr, 30 phr to 60 phr, about 40 phr to about 50 phr, and 40 phr to 50 phr.

As used herein, the term “reinforcing” with respect to reinforcing filler, generally should be understood to encompass both fillers that are traditionally described as reinforcing as well as fillers that may be described as semi-reinforcing. Traditionally, the term “reinforcing filler” is used to refer to a particulate material that has a nitrogen absorption specific surface area (N₂SA) of more than about 100 m²/g, and in certain instances more than 100 m²/g, more than about 125 m²/g, more than 125 m²/g, or even more than about 150 m²/g or more than 150 m²/g. Alternatively, the traditional use of the term “reinforcing filler” can also be used to refer to a particulate material that has a particle size of about 10 nm to about 50 nm (including 10 nm to 50 nm). Traditionally, the term “semi-reinforcing filler” is used to refer to a filler that is intermediary in either particle size, surface area (N₂SA), or both, to a non-reinforcing filler and a reinforcing filler. In certain embodiments disclosed herein, the term “reinforcing filler” is used to refer to a particulate material that has a nitrogen absorption specific surface area (N₂SA) of about 20 m²/g or greater, including 20 m²/g or greater, more than about 50 m²/g, more than 50 m²/g, more than about 100 m²/g, more than 100 m²/g, more than about 125 m²/g, and more than 125 m²/g. In certain embodiments disclosed herein, the term “reinforcing filler” is used to refer to a particulate material that has a particle size of about 10 nm up to about 1000 nm, including 10 nm to 1000 nm, about 10 nm up to about 50 nm and 10 nm to 50 nm.

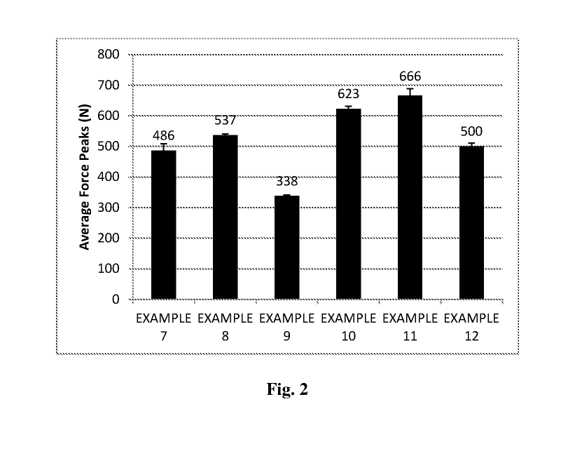

The reinforcing filler provides improved strength and durability to the adhesive composition as compared to a similar composition without any reinforcing filler. FIG. 2 illustrates the effect on the force required to separate two adhered rubber components seen in certain adhesive compositions with and without reinforcing filler, the formulations of which are further described in later examples.

In one or more embodiments, the at least one reinforcing filler may be chosen from the group consisting of carbon black, silica, and mixtures thereof. In those embodiments in which the adhesive composition comprises carbon black, the carbon black may be present in an amount of about 40 phr to about 60 phr, including 40 phr to 60 phr, about 40 phr to about 50 phr, and 40 phr to 50 phr. Generally, suitable carbon black for use in the adhesive composition of certain embodiments disclosed herein includes any of the commonly available, commercially-produced carbon blacks, including those having a surface area of at least about 20 m²/g (including at least 20 m²/g) and, more preferably, at least about 35 m²/g up to about 200 m²/g or higher (including 35 m²/g up to 200 m²/g). Surface area values used in this application are determined by ASTM D-1765 using the cetyltrimethyl-ammonium bromide (CTAB) technique. Among the useful carbon blacks are furnace black, channel blacks, and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which can be utilized include acetylene blacks. In certain embodiments disclosed herein, the adhesive composition may include a mixture of two or more of the foregoing blacks. Typical suitable carbon blacks for use in certain embodiments of the first-third embodiments disclosed herein are N-110, N-220, N-339, N-330, N-351, N-550, and N-660, as designated by ASTM D-1765-82a. The carbon blacks utilized can be in pelletized form or an unpelletized flocculent mass. Preferably, for more uniform mixing, unpelletized carbon black is preferred.

In those embodiments in which the adhesive composition includes silica, suitable reinforcing silica fillers are well known. Non-limiting examples of reinforcing silica fillers suitable for use in the adhesive composition of certain embodiments disclosed herein include, but are not limited to, precipitated amorphous silica, wet silica (hydrated silicic acid), dry silica (anhydrous silicic acid), fumed silica, calcium silicate and the like. Other suitable reinforcing silica fillers for use in rubber compositions of certain embodiments disclosed herein include, but are not limited to, aluminum silicate, magnesium silicate (Mg₂SiO₄, MgSiO₃ etc.), magnesium calcium silicate (CaMgSiO₄), calcium silicate (Ca₂SiO₄ etc.), aluminum silicate (Al₂SiO₅, Al₄.3SiO₄.5H₂O etc.), aluminum calcium silicate (Al₂O₃.CaO₂SiO₂, etc.), and the like. Among the listed reinforcing silica fillers, precipitated amorphous wet-process, hydrated silica fillers are preferred. Such reinforcing silica fillers are produced by a chemical reaction in water, from which they are precipitated as ultrafine, spherical particles, with primary particles strongly associated into aggregates, which in turn combine less strongly into agglomerates. The surface area, as measured by the BET method, is a preferred measurement for characterizing the reinforcing character of different reinforcing silica fillers. In certain embodiments disclosed herein, the rubber composition comprises a reinforcing silica filler having a surface area (as measured by the BET method) of about 32 m²/g to about 400 m²/g (including 32 m²/g to 400 m²/g), with the range of about 100 m²/g to about 300 m²/g (including 100 m²/g to 300 m²/g) being preferred, and the range of about 150 m²/g to about 220 m²/g (including 150 m²/g to 220 m²/g) being included. In certain embodiments disclosed herein, the rubber composition comprises reinforcing silica filler having a pH of about 5.5 to about 7 or slightly over 7, preferably about 5.5 to about 6.8. Some of the commercially available reinforcing silica fillers which can be used in the rubber compositions of certain embodiments of the first-third embodiments disclosed herein include, but are not limited to, Hi-Sil®190, Hi-Sil®210, Hi-Sil®215, Hi-Sil®233, Hi-Sil®243, and the like, produced by PPG Industries (Pittsburgh, Pa.). As well, a number of useful commercial grades of different reinforcing silica fillers are also available from Degussa Corporation (e.g., VN2, VN3), Rhone Poulenc (e.g., Zeosil™ 1165MP), and J. M. Huber Corporation.

In certain embodiments disclosed herein, the reinforcing silica filler comprises a silica that has been pre-treated with a silica coupling agent; preferably the pre-treated silica comprises a silica that has been pre-treated with a silane-containing silica coupling agent. In other embodiments, the silica filler is used in combination with a silane-containing silica coupling agent, but is not pretreated (e.g. both are added to the rubber composition as separate ingredients). Generally, any conventional type of silica coupling agent can be used, such as those having a silane and a constituent component or moiety that can react with a polymer, particularly a vulcanizable polymer. The silica coupling agent acts as a connecting bridge between silica and the polymer. Suitable silica coupling agents include, but are not limited to, those containing groups such as alkyl alkoxy, mercapto, blocked mercapto, sulfide-containing (e.g., monosulfide-based alkoxy-containing, disulfide-based alkoxy-containing, tetrasulfide-based alkoxy-containing), amino, vinyl, epoxy, and combinations thereof. In certain embodiments, the silica coupling agent can be added to the adhesive composition in the form of a pre-treated silica; a pre-treated silica has been pre-surface treated with a silane prior to being added to the rubber composition. The use of a pre-treated silica can allow for two ingredients (i.e., silica and a silica coupling agent) to be added in one ingredient, which generally tends to make rubber compounding easier.

In certain embodiments disclosed herein, the adhesive composition may include additional reinforcing fillers. Non-limiting examples of suitable additional reinforcing fillers for use in the adhesive composition of certain embodiments disclosed herein include, but are not limited to, alumina, aluminum hydroxide, clay, magnesium hydroxide, boron nitride, aluminum nitride, titanium dioxide, reinforcing zinc oxide, and combinations thereof. Suitable inorganic fillers for use in the adhesive composition are not particularly limited and non-limiting examples include: silica, aluminum hydroxide, talc, clay, alumina (Al₂O₃), aluminum hydrate (Al₂O₃H2O), aluminum hydroxide (Al(OH)₃), aluminum carbonate (Al₂(CO₃)₂), aluminum nitride, aluminum magnesium oxide (MgOAl₂O₃), pyrofilite (Al₂O₃.4SiO2.H2O), bentonite (Al₂O₃.4SiO₂.2H₂O), boron nitride, mica, kaolin, glass balloon, glass beads, calcium oxide (CaO), calcium hydroxide (Ca(OH)₂), calcium carbonate (CaCO₃), magnesium carbonate, magnesium hydroxide (MH(OH)₂), magnesium oxide (MgO), magnesium carbonate (MgCO₃), titanium oxide, titanium dioxide, potassium titanate, barium sulfate, zirconium oxide (ZrO₂), zirconium hydroxide [Zr(OH)₂.nH₂O], zirconium carbonate [Zr(CO₃)₂], crystalline aluminosilicates, reinforcing grades of zinc oxide (i.e., reinforcing zinc oxide), and combinations thereof.

### Cure Package

In certain embodiments of the second-fourth embodiments, the adhesive composition further comprises a cure package, thereby rendering the composition curable. In one or more of such embodiments, the cure package comprises a curing agent and at least one vulcanization accelerator which acts as a catalyst for the curing agent. The addition of curing agents in the adhesive compositions disclosed herein is shown to result in adhesion properties, as shown in FIG. 2. The peel resistance of the adhesive bond between two rubber components adhered with the curable adhesive composition in certain embodiments of the second-fourth embodiments may withstand between 300N to 800N, including 300N to 500N, 500N to 700N and 600N to 800N, of separating force when using an intervening nylon mesh interface between the surfaces of the rubber components to prevent fracturing of the rubber sheets.

Examples of suitable types of curing agents for use in the rubber compositions according to certain embodiments of the second-fourth embodiments include, but are not limited to, sulfur or peroxide-based curing components. Thus, in certain such embodiments, the curative component includes a sulfur-based curative or a peroxide-based curative. Examples of specific suitable sulfur vulcanizing agents include “rubbermaker's” soluble sulfur; sulfur donating curing agents, such as an amine disulfide, polymeric polysulfide, or sulfur olefin adducts; and insoluble polymeric sulfur. Preferably, the sulfur curing agent is soluble sulfur or a mixture of soluble and insoluble polymeric sulfur. In these embodiments which comprise sulfur, the sulfur is present in an amount of about 1 to about 5 phr, 1 phr to 5 phr, about 1 phr to about 4 phr, 1 phr to 4 phr, about 1.5 phr to about 3 phr, and 1.5 phr to 3 phr.

Vulcanizing accelerators are used to control the time and/or temperature required for vulcanization and to improve properties of the vulcanizate. Examples of suitable vulcanizing accelerators for use in the rubber compositions according to certain embodiments of the second-fourth embodiments disclosed herein include, but are not limited to, thiazole vulcanization accelerators, such as 2-mercaptobenzothiazole, 2,2′-dithiobis(benzothiazole) (MBTS), N-cyclohexyl-2-benzothiazole-sulfenamide (CBS), N-tert-butyl-2-benzothiazole-sulfenamide (TBBS), and the like; guanidine vulcanization accelerators, such as diphenyl guanidine (DPG) and the like; thiuram vulcanizing accelerators; carbamate vulcanizing accelerators; and the like. In certain such embodiments, the at least one vulcanization accelerator is present in a total amount of about 0.5 to about 5 phr, including 0.5 phr to 5 phr, about 1 phr to about 5 phr, 1 phr to 5 phr, about 1 phr to about 4 phr, 1 phr to 4 phr, about 1.5 phr to about 3 phr, and 1.5 phr to 3 phr.

The cure package of certain embodiments of the second-fourth embodiments may also comprise a vulcanization activator, vulcanizing inhibitor, and an anti-scorching agent. Vulcanizing activators are additives used to support vulcanization. Generally, vulcanizing activators include both an inorganic and organic component. Zinc oxide is the most widely used inorganic vulcanization activator. Various organic vulcanization activators are commonly used including stearic acid, palmitic acid, lauric acid, and zinc salts of each of the foregoing. Vulcanization inhibitors are used to control the vulcanization process and generally retard or inhibit vulcanization until the desired time and/or temperature is reached. Common vulcanization inhibitors include, but are not limited to, PVI (cyclohexylthiophthalmide) from Santogard. Vulcanizing inhibitors and anti-scorching agents are known in the art and can be selected by one skilled in the art based on the vulcanizate properties desired.

For a general disclosure of suitable curing agents and other components used in curing, e.g., vulcanizing inhibitor and anti-scorching agents, one can refer to Kirk-Othmer, Encyclopedia of Chemical Technology, 3rd ed., Wiley Interscience, N.Y. 1982, Vol. 20, pp. 365 to 468, particularly Vulcanization Agents and Auxiliary Materials, pp. 390 to 402, or Vulcanization by A. Y. Coran, Encyclopedia of Polymer Science and Engineering, Second Edition (1989 John Wiley & Sons, Inc.), both of which are incorporated herein by reference.

### Other Components of Adhesive Composition

Other ingredients that may be employed in the rubber compositions of certain embodiments of the first-fourth embodiments disclosed herein are well known to those of skill in the art and include oils (processing and extender), waxes, processing aids, antioxidants, tackifying resins, reinforcing resins, peptizers, and one or more additional rubbers.

Various types of processing and extender oils may be utilized, including, but not limited to aromatic, naphthenic, and low PCA oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom. Suitable low PCA oils include mild extraction solvates (MES), treated distillate aromatic extracts (TDAE), TRAE, and heavy naphthenics. Suitable MES oils are available commercially as CATENEX SNR from SHELL, PROREX 15, and FLEXON 683 from EXXONMOBIL, VIVATEC 200 from BP, PLAXOLENE MS from TOTAL FINA ELF, TUDALEN 4160/4225 from DAHLEKE, MES-H from REPSOL, MES from Z8, and OLIO MES S201 from AGIP. Suitable TDAE oils are available as TYREX 20 from EXXONMOBIL, VIVATEC 500, VIVATEC 180, and ENERTHENE 1849 from BP, and EXTENSOIL 1996 from REPSOL. Suitable heavy naphthenic oils are available as SHELLFLEX 794, ERGON BLACK OIL, ERGON H2000, CROSS C2000, CROSS C2400, and SAN JOAQUIN 2000L. Suitable low PCA oils also include various plant-sourced oils such as can be harvested from vegetables, nuts, and seeds. Non-limiting examples include, but are not limited to, soy or soybean oil, sunflower oil, safflower oil, corn oil, linseed oil, cotton seed oil, rapeseed oil, cashew oil, sesame oil, camellia oil, jojoba oil, macadamia nut oil, coconut oil, and palm oil. The foregoing processing oils can also be used as an extender oil, i.e., to prepare an oil-extended polymer or copolymer.

Various antioxidants are known to those of skill in the art and may be utilized in the rubber compositions of certain embodiments of the first-fourth embodiments; these include but are not limited to phenolic antioxidants, amine phenol antioxidants, hydroquinone antioxidants, alkyldiamine antioxidants, and amine compound antioxidants such as N-phenyl-N′-isopropyl-p-phenylenediamine (IPPD), or N-(1,3-dimethylbutyl)-N′-phenyl-phenylenediamine (6PPD). One or more than one type as well as one or more than one of each type may be utilized in certain embodiments of the first-fourth embodiments.

As discussed above, according to the first-fourth embodiments disclosed herein, the adhesive composition or curable adhesive composition is essentially free of petroleum-based solvents and petroleum-based resins. By stating that the adhesive composition or curable adhesive composition is essentially free of petroleum-based solvents and petroleum-based resins is meant that the amount of such components in the adhesive composition is limited. In certain embodiments of the first-fourth embodiments, the adhesive composition or curable adhesive composition is essentially free of petroleum-based solvents and petroleum-based resins such that no more than 10% by weight of the adhesive composition comprises petroleum-based solvent(s), petroleum-based resin(s), or a combination thereof. In certain embodiments of the first-fourth embodiments, the adhesive composition or curable adhesive composition is essentially free of petroleum-based solvents and petroleum-based resins such that no more than 9% by weight, no more than 8% by weight, no more than 7% by weight, no more than 6% by weight, no more than 5% by weight, no more than 4% by weight, no more than 3% by weight, no more than 2% by weight, no more than 1% by weight, no more than 0.5% by weight or even 0% by weight of the adhesive composition or curable adhesive composition comprises petroleum-based solvent(s), petroleum-based resin(s), or a combination thereof.

### Methods and Articles of Manufacture

In one or more embodiments, the adhesive composition comprises at least one of a conjugated diene-containing polymer or copolymers including natural rubber and a liquid terpene-based solvent, wherein the adhesive composition is essentially free of petroleum-based solvents and petroleum-based resins may be applied to a rubber surface of a first tire component, thereby forming an adhesive-containing first rubber surface. After forming an adhesive-containing first rubber surface, at least a portion of a second rubber surface of a second tire component may be contacted with at least a portion of the adhesive-containing first rubber surface to form two adhered components. In one or more embodiments, the adhesive composition may be applied to at least a portion of the second rubber surface of the second tire component prior to contacting the respective rubber surfaces of the first and second tire components.

In one or more embodiments, the adhesive composition may be applied to one or more rubber components to be adhered by means of a brush, roller or spray. In these embodiments, the adhesive composition may be applied in an amount of 1 g/ft² to 15 g/ft², including 1 g/ft² to 12 g/ft², 1 g/ft² to 10 g/ft², 1 g/ft² to 8 g/ft², 1 g/ft² to 7 g/ft², 1 g/ft² to 6 g/ft², 1 g/ft² to 5 g/ft², as well as 3 g/ft² to 15 g/ft², 3 g/ft² to 12 g/ft², 3 g/ft² to 10 g/ft², 3 g/ft² to 8 g/ft², 3 g/ft² to 7 g/ft², 5 g/ft² to 15 g/ft², 5 g/ft² to 12 g/ft², 5 g/ft² to 10 g/ft², 5 g/ft² to 8 g/ft², and 5 g/ft² to 7 g/ft². In one or more embodiments, the adhesive composition is applied to the surface of each rubber component that is to be adhered (e.g., if two components are to be adhered, the adhesive composition is applied to the surface of each component), including in the foregoing amounts. In one or more other embodiments, the adhesive composition is applied to the surface of one rubber component that is to be adhered (e.g., if two components are to be adhered, the adhesive composition is applied to the surface of one of the components), including in the foregoing amounts.

After application, the adhesive composition disclosed herein may be cured under conditions appropriate for the rubber components to which it has been applied. Those of skill in the art will be familiar with such conditions which may include appropriate temperature, time and pressure. As a non-limiting example, in one or more embodiments, after application the adhesive composition may be cured at a temperature of about 14CPC to about 175° C., including 14CPC to 175° C., for about 15 minutes to about 35 minutes, including 15 minutes to 35 minutes, at a pressure of about 70 psi to about 120 psi, including, for example, 100 psi.

In certain embodiments of the second-fourth embodiment, the liquid terpene-based solvent is present in a detectable amount after being subjected to said curing process. Thus, after curing, it is believed that there exists a residual amount of solvent-containing adhesive.

In an embodiment, a tire may be manufactured comprising at least two rubber components adhered by the process described in one or more embodiments of the third embodiment. Thus, disclosed herein in an embodiment is a tire containing at least two components adhered by (a) providing a first tire component having a first rubber surface, and applying to at least a portion of the first rubber surface a curable adhesive composition comprising at least one conjugated diene-containing polymer or copolymer including natural rubber, a liquid terpene-based solvent, and a cure package, wherein the curable adhesive composition is essentially free of petroleum-based solvents and petroleum-based resins; (b) providing a second tire component having a second rubber surface; and (c) contacting at least a portion of the second rubber surface with at least a portion of the adhesive-containing first rubber surface to form two adhered components.

### EXAMPLES

The following examples illustrate specific embodiments and/or features of the embodiments of the present disclosure. The examples provided below are for illustrative purposes and should in no way be construed as limiting the disclosure in any way. In particular, it should be understood that the liquid terpene-based solvents used in the following examples can be utilized with polymer(s) or copolymer(s), reinforcing filler(s), and other ingredients that vary in type, identity, amount or a combination thereof from those used in the examples as fully disclosed above. Moreover, liquid terpene-based solvents that differ in type and amount from those used in the examples can be utilized as disclosed fully above. Finally, the term “process aids” is used below to generally refer to additional components found in the adhesive compositions, which may include, but are not limited to, oils (processing and extender), waxes, antioxidants, tackifying resins, reinforcing resins, and peptizers.

### Examples 1-6

In examples 1-3, adhesive compositions containing a combination of styrene-butadiene rubber and natural rubber polymer were prepared using varying amounts of orange oil (D-Limonene FF880727088, Citrus World, Inc., Lake Wales, Fla.) which comprises 95% to 100% d-limonene, as the liquid terpene-based solvent, the components of which are listed in Table 1. Example 1 contains no orange oil, but rather contains approximately 90% by weight petroleum-based solvent, namely heptane, and can be used as a control. Example 2 contains approximately 90% by weight of orange oil solvent. Example 3 contains approximately 60% by weight of orange oil solvent.

In examples 4-6, adhesive compositions containing 100 parts of natural rubber were prepared using varying amounts of orange oil as the solvent, the components of which are listed in Table 1. Example 4 contains no orange oil, but rather contains approximately 91% by weight petroleum-based solvent and can be used as a control. Example 5 contains approximately 91% by weight of orange oil solvent. Example 6 contains approximately 60% by weight of orange oil solvent.

The samples were prepared by mixing the rubber (solid) component in an internal mixer. The rubber was then shredded into small pieces and placed in a jar with the respective amount of orange oil. The mixture was shaken for at least 3 hours, and then sonicated for one hour to finish dissolving. Similar samples may also be prepared by mixing with an impeller mixer for at least 5 hours and allowed to sit overnight, followed by mixing for another 2 hours.

The relative peel resistance of the adhesive bond between two components adhered with the adhesive compositions can be viewed in FIG. 1. The peel resistance was measured under the guidance of (but not strictly according to) ASTM D1876-08 (2015). The force reported in these examples was measured using an intervening nylon mesh interface placed between the two components to ensure that the two adhered components separated at the interface rather than tearing the adherends of the adhered components.

TABLE 1

| | |
|---|---|
| Component | Amount |

EXAMPLE 1

| | | |
|---|---|---|
| Styrene-butadiene rubber | 40 | parts |
| Natural rubber | 60 | parts |
| Carbon black | 50 | phr |
| Process aids | 42 | phr |
| Cure package | 11 | phr |
| Heptane | 1912 | phr |

EXAMPLE 2

| | | |
|---|---|---|
| Styrene-butadiene rubber | 40 | parts |
| Natural rubber | 60 | parts |
| Carbon black | 50 | phr |
| Process aids | 42 | phr |
| Cure package | 11 | phr |
| Orange oil | 1912 | phr |

EXAMPLE 3

| | | |
|---|---|---|
| Styrene-butadiene rubber | 40 | parts |
| Natural rubber | 60 | parts |
| Carbon black | 50 | phr |
| Process aids | 42 | phr |
| Cure package | 11 | phr |
| Orange oil | 304 | phr |

EXAMPLE 4

| | | |
|---|---|---|
| Natural rubber | 100 | parts |
| Carbon black | 50 | phr |
| Process aids | 8 | phr |
| Cure package | 9 | phr |
| Heptane | 1665 | phr |

EXAMPLE 5

| | | |
|---|---|---|
| Natural rubber | 100 | parts |
| Carbon black | 50 | phr |
| Process aids | 8 | phr |
| Cure package | 9 | phr |
| Orange oil | 1912 | phr |

EXAMPLE 6

| | | |
|---|---|---|
| Natural rubber | 100 | parts |
| Carbon black | 50 | phr |
| Process aids | 8 | phr |
| Cure package | 9 | phr |
| Orange oil | 250 | phr |

### Examples 7-12

In examples 7-9, curable adhesive compositions containing a combination of styrene-butadiene rubber and natural rubber polymer were prepared using approximately 91% by weight of orange oil solvent and varying amounts of reinforcing filler and cure package ingredients, the components of which are listed in Table 2. Example 7 contains both carbon black filler and cure package ingredients. Example 8 contains carbon black filler and no cure package ingredients. Example 9 contains cure package ingredients and no carbon black filler.

In examples 10-12, adhesive compositions containing only natural rubber polymer were prepared using approximately 91% by weight of orange oil solvent and varying amounts of filler and cure package ingredients, the components of which are listed in Table 2. Example 10 contains both carbon black filler and cure package ingredients. Example 11 contains carbon black filler and no cure package ingredients. Example 12 contains cure package ingredients and no carbon black filler.

The relative adhesive strength of the rubber compositions of Examples 7-12 can be viewed in FIG. 2 and was measured in the same manner as in Examples 1-6 discussed above.

TABLE 2

| | |
|---|---|
| Component | Amount |

EXAMPLE 7

| | | |
|---|---|---|
| Styrene-butadiene rubber | 40 | parts |
| Natural rubber | 60 | parts |
| Carbon black | 50 | phr |
| Process aids | 42 | phr |
| Cure package | 11 | phr |
| Orange oil | 2027 | phr |

EXAMPLE 8

| | | |
|---|---|---|
| Styrene-butadiene rubber | 40 | parts |
| Natural rubber | 60 | parts |
| Carbon black | 50 | phr |
| Process aids | 42 | phr |
| Cure package | 7 | phr |
| Orange oil | 1990 | phr |

EXAMPLE 9

| | | |
|---|---|---|
| Styrene-butadiene rubber | 40 | parts |
| Natural rubber | 60 | parts |
| Carbon black | 0 | phr |
| Process aids | 42 | phr |
| Cure package | 11 | phr |
| Orange oil | 1527 | phr |

EXAMPLE 10

| | | |
|---|---|---|
| Natural rubber | 100 | parts |
| Carbon black | 50 | phr |
| Process aids | 8 | phr |
| Cure package | 9 | phr |
| Orange oil | 1665 | phr |

EXAMPLE 11

| | | |
|---|---|---|
| Natural rubber | 100 | parts |
| Carbon black | 50 | parts |
| Process aids | 8 | phr |
| Cure package | 4 | phr |
| Orange oil | 1621 | phr |

EXAMPLE 12

| | | |
|---|---|---|
| Natural rubber | 100 | parts |
| Carbon black | 0 | phr |
| Process aids | 8 | phr |
| Cure package | 9 | phr |
| Orange oil | 1165 | phr |

This application discloses several numerical range limitations that support any range within the disclosed numerical ranges, even though a precise range limitation is not stated verbatim in the specification, because the embodiments of the compositions and methods disclosed herein could be practiced throughout the disclosed numerical ranges. With respect to the use of substantially any plural or singular terms herein, those having skill in the art can translate from the plural to the singular or from the singular to the plural as is appropriate to the context or application. The various singular or plural permutations may be expressly set forth herein for sake of clarity.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references, including but not limited to patents, patent applications, and non-patent literature are hereby incorporated by reference herein in their entirety.

While various aspects and embodiments of the invention have been disclosed herein, these descriptions, however detailed, are for illustrative purposes and are not meant to limit the scope of the claims in any way. Additional aspects and embodiments will be apparent to those skilled in the art, and it is intended that any such additional aspects and embodiments be encompassed herein to the extent that they fall within the scope of the claims.

What is claimed is:

1-18. (canceled)

19. An adhesive composition for tires comprising:
a. 100 parts of at least one conjugated diene-containing polymer or copolymer including natural rubber, and
b. about 60% to about 95% by weight of liquid terpene-based solvent based upon the weight of the adhesive composition,
wherein the adhesive composition is essentially free of petroleum-based solvents and petroleum-based resins.

20. The adhesive composition of claim 19 wherein the liquid terpene-based solvent comprises a citrus oil.

21. The adhesive composition of claim 19, wherein a majority by weight of the liquid terpene-based solvent comprises d-limonene.

22. The adhesive composition of claim 19, wherein the liquid terpene-based solvent is essentially free of water.

23. The adhesive composition of claim 19, wherein a majority by weight of the 100 parts of at least one conjugated diene-containing polymer or copolymer comprises natural rubber.

24. The adhesive composition of claim 19, wherein the adhesive composition comprises at least one reinforcing filler.

25. The adhesive composition of claim 24, wherein the at least one reinforcing filler is present in an amount of about 25 to about 75 phr.

26. The adhesive composition of claim 24, wherein the at least one reinforcing filler comprises carbon black.

27. The adhesive composition of claim 26, wherein the carbon black is present in an amount of about 40 to about 60 phr.

28. The adhesive composition of claim 23, wherein the at least one conjugated diene-containing polymer or copolymer further comprises at least one polymer or copolymer selected from styrene-butadiene copolymer, polybutadiene, and polyisoprene.

29. A curable adhesive composition for tires comprising:
a. 100 parts of at least one conjugated diene-containing polymer or copolymer including natural rubber,
b. about 60% to about 95% by weight of liquid terpene-based solvent based upon the weight of the curable adhesive composition, and
c. a cure package,
wherein the adhesive composition is essentially free of petroleum-based solvents and petroleum-based resins.

30. The curable adhesive composition of claim 29, wherein the cure package comprises sulfur and at least one vulcanization accelerator.

31. The curable adhesive composition of claim 30, wherein the sulfur is present in an amount of about 1 to about 5 phr, and the at least one vulcanization accelerator is present in an amount of about 0.5 to about 5 phr.

32. The curable adhesive composition of claim 29, wherein the liquid terpene-based solvent comprises a citrus oil.

33. The curable adhesive composition of claim 29, wherein a majority by weight of the liquid terpene-based solvent comprises d-limonene.

34. The curable adhesive composition of claim 29, wherein a majority by weight of the 100 parts of at least one conjugated diene-containing polymer or copolymer comprises natural rubber.

35. The curable adhesive composition of claim 29, wherein the adhesive composition comprises at least one reinforcing filler in an amount of about 25 to about 75 phr.

36. The curable adhesive composition of claim 35, wherein the at least one reinforcing filler comprises carbon black in an amount of about 40 to about 60 phr.

37. A process for adhering two tire components together, the process comprising:
a. providing a first tire component having a first rubber surface, and applying to at least a portion of the first rubber surface a curable adhesive composition comprising:
i. 100 parts of at least one conjugated diene-containing polymer or copolymer including natural rubber,
ii. about 60% to about 95% by weight of liquid terpene-based solvent based upon the weight of the curable adhesive composition, and
iii. a cure package,
thereby forming an adhesive-containing first rubber surface;
b. providing a second tire component having a second rubber surface; and
c. contacting at least a portion of the second rubber surface with at least a portion of the adhesive-containing first rubber surface to form two adhered components.

38. The process of claim 37, wherein the curable adhesive composition is applied to at least a portion of the second rubber surface of the second tire component prior to (c).
